(19) United States
(12) Patent Application Publication
(10) Pub. No.: US 2003/0009362 A1
(43) Pub. Date: Jan. 9, 2003

(54) Collaborative eCommerce program management arrangement , resulting in a new generation and classification of web site establishments on the internet

(76) Inventors: Chester John Cifani, Rochester, MI (US); Michael Chester Cifani, Rochester, MI (US)

Correspondence Address: CHESTER J. CIFANI, 5845 LIVERNOIS, ROCHESTER, MI, 48306-2539, US

(21) Appl. No.: 09/885,838

(22) Filed: Jun. 20, 2001

(51) Int. Cl. G06F 17/60; H04L 9/00; H04K 1/00

(52) U.S. Cl. 705/7; 709/218; 705/51

(57) ABSTRACT

The present invention is directed to Web site establishments on the Internet, presently referred as Portals, Anchor Sites, Search Engines, Infomediaries, or Regional Theme Sites™. Specifically, the present invention relates to a novel method and apparatus (FIG. 3) for a Web site establishment (7), to create a business affiliation with outside business customers (21). Because of the revolutionary features, nature, and class of Web site created as a result of this invention, along with the fact that the outside business customers interact with similar outside business customers in a collaborative and non-combative arrangement, the Web site establishment could be more appropriately labeled a “collaborative Portal” or “coPortal” (7). In the preferred embodiment of the invention, instead of the coPortal selling “space” to outside corporate customers (which is typically the arrangement in the prior art relative to displaying banner ads and/or links), what is contractually sold is “equity owner” membership (17, 18) into a “coPortal Program Management Team” (or cPMT), which controls the appearance and/or content of the coPortal. The coPortal Program Management (cPM) invention requires each outside business customer or CBM to assign a company representative/contact or CCM (16), who is then assigned to a specific cPMT (15). Each CCM interfaces and actively co-exists with other CCM participants/members in a collaborative non-combative manner, under the guidance, direction, and control of a Program Manager who reports to the coPortal (13). While the preferred embodiment of the invention is best applied on the content arrangement found on Niche Portals, or Regional Theme Sites, it can also be applied to other channels such as General Portals, Anchor Web sites, Infomediaries, Search Engines, etc.

### CROSS-REFERENCE TO RELATED APPLICATIONS

There are no prior filed copending nonprovisional patent applications/inventions that are known to the inventors.

### BACKGROUND OF THE INVENTION

There were many early beliefs and myths concerning the Internet that came out during its explosive growth period that started in the mid-'90's, that still dictates and explains the manner in which we conduct business, as it relates to advertising, marketing, affiliating with Web site establishments, and connecting with your end-user/customer. One of the very early myths was that the Internet is only a place for virtual businesses that have absolutely no connection or association with “brick and mortar” corporations, whose traditional economic models of doing business based on profitability could adversely affect the Internet's “new economy” philosophy. Ironically, what helped to foster this myth was that traditional “brick and mortar” corporations (perhaps because of their size and longer time to “get to market”) were slow in embracing the Internet and establishing a presence.

The “pure-play” or “clicks only” eCommerce business model eventually gave way, and expanded to “bricks and clicks” in the late 1990's, when it was determined that financial viability on the Internet could be greatly enhanced with the partnering and/or support of traditional “brick and mortar” corporations. At the time of this writing the “new economy” mentality had finally come full circle, wherein certain schools of thought are suggesting that the Internet belongs only to “brick and mortar” corporations or enterprises, and that “pure-play” or “pure-online” commercial Web sites was only an experiment, a thing of the past, and destined for failure.

Another myth that arose during the Internet's developmental years was that the Internet is an all-new stand-alone Industry (much like the Automotive Industry, Computer Industry, Pharmaceutical Industry, etc.), instead of realizing that it is nothing more than another “medium” for existing Industries and Society in general. Understanding the difference between this myth and reality helps to understand and explain the tremendous numbers of Internet startups that have gone bankrupt or in financial disarray. Even traditional “brick and mortar” corporations accepted this myth, and made the same blinded-mistakes as the other non-“brick and mortar” startups. This is evident when we look at the many Parent “brick and mortar” corporations that created and spun-off “stand-alone” Internet business entities/corporations (such as PetsMart, Staples, and NBC), only to find out that they could not survive independently on their own. As a result, they had to close down these operations (as a separate legal entity), and brought the affected employees and their responsibilities back into the Parent organization. Additionally, there are other struggling (“pure Online and independent”) legal entities (such as BarnesandNoble.com, ToysrUs.com, and BlueLight.com—for KMart) whose stand-alone legal arrangement could possibly be curtailed in the very near future, and then brought back into their Parent organization.

The Internet went through it's “big-bang” growth phase in the mid-to-late 1990's, under the beliefs and practices that survivability and growth, was in direct correlation to the speed of spending money to promote your (Internet/Web) brand name. The assumption associated to this myth was that the winners would only be those first few Web sites that had strong customer loyalty along with brand name recognition. Moreover, since money was especially abundant, it was very easy to go through heavy/costly advertising or promotional marketing campaigns. As a result, “pure-play” Internet companies (especially those that were straddled with far-off names that told nothing of the nature of the company) experienced a cash “burn rate” which was previously unmatched in the business world, wherein losses on a quarterly basis (for a seemingly endless list of Internet companies) was measured in tens of millions, hundreds of millions, or even billions of dollars. Furthermore, those few Web site establishments that made any money at all (from the context of web sites that we will define later) could be counted on only one hand. Moreover, the ratio of profit/loss to revenue were such disparate numbers, that the question was not “if” the enterprise was going to go bankrupt, get bought out, or get folded back into the Parent corporation, but “when”.

Initially banner ads represented a unique and novel Internet marketing tool, it provided an ideal means for consumers to instantly connect with the advertiser, and it's sponsors saw it as a fabulous Web-based medium to achieve its advertising initiative for brand name recognition. When it was introduced in 1994, banner ads enjoyed a robust “click through rate” of 10%, which greatly pleased Web site establishments that displayed these banner ads for a great source of revenue, and also excited the outside business customers who paid the Web site establishment for displaying the banner ads. Since those early days banner ads have noticed a steady decline/acceptance, to where they are presently experiencing “click rates” under 1.0%. In effect, consumers have become sensitized to banner ads, and through time, banner ads have lost their effectiveness.

This abysmally low “click rate” for banner ads or links is spelling disaster for both the outside customer who wants to advertise or market their product, service, or Web site, as well as the Web site establishment that displays banner advertisements to gain revenue. In an attempt to stimulate the hit rate of banner ads, the Interactive Advertising Bureau—formerly the Internet Advertising Bureau (composed of IAB member companies America Online, CNET Networks, Inc., Double Click, Excite@Home, MSN, New York Times Digital, Phase2Media, Snowball, Terra Lycos, Walt Disney, Internet Group and Yahoo) announced a new larger sized array of banner ads on Feb. 26, 2001, with the hope that this new “in your face” larger foot-print would re-stimulate banner ads, and generate a significantly higher click rate.

With the approval of the larger banner ads, the IAB association effectively gave further endorsement to the long standing myth that banner ads are “the method” to market or advertise products and services on the Internet, as well as being the basic method for generating revenue for a Web site establishment. While it is still too early to determine the long-term click rate improvement associated with the new larger banner ads, the short-term assessment shows that the click rate has still remained well below 1.0%. While many activities praise the values of banner ads, there are probably double or triple the number that feel banner ads have outlived their usefulness and utility, and are yearning for an alternative marketing and advertising formula/product, as well as a better way to connect with the ultimate end-user/consumer/customer.

Another simultaneous occurrence taking form on the Web is the method in which “mainstream information” (on a broad and basic level) was being marketed and made available to the mass (Internet) users. The four mainstream distribution channels that eventually developed (that are also sometime referred to or known as “Anchor Web Sites” or “Infomediaries”), along with examples, are summarized in Table-A directly below:

TABLE A
1. General Portals

| | | | |
|---|---|---|---|
| Yahoo.com | Excite.com | MSN.com | Go.com |
| AltaVista.com | iWon.com | About.com | AOL.com |
| Lycos.com | Netscape.com | | |

2. Niche Portals
iVillage.com (for women)
Garden.com (for gardeners)
Fool.com (for investors)
SearchNT.com (for Windows NT administrators)
TheStandard.com (for Internet aficionados)
USAToday.com (for news)
3. Pure Search Engines

| | | | |
|---|---|---|---|
| Dogpile.com | Google.com | HotBot.com | Directhit.com |
| Looksmart.com | | | |

4. Pay-For-Performance Search Engines

| | | | |
|---|---|---|---|
| GoTo.com | Findwhat.com | Sprinks.com | Bay9.com |
| Kanoodle.com | | | |

In effect everyone that has used the Internet up till now, have relied on one of these four types of channels (that could be further summarized into just two groups—Portals & Search Engines), either as being a means or “launch pad” to travel to other Web site destinations (including “brick and mortar” corporate web sites, informational, community, or entertainment Web sites), or as a beginning and end-point for their Internet journey. Furthermore, according to Nielsen Net Ratings, the top four Global Internet Web sites for the month of March 2001 (Yahoo, AOL, MSN, and Lycos—listed in descending order) are all General Portals, and upon closer examination we find that some of the other General Portals listed in Table-A are also listed in the top-25 (Excite—6^{th} position, About—7th, and AltaVista—14th). All of this points to the strength and power of General Portals as the pre-eminent Internet communication channel.

But it is also disheartening to note that all of the Portals and Search Engines listed in the top-25 Global Web sites, as well as those remaining Portals and Search Engines listed in Table-A, deal with outside customers in the same passive manner and fashion. Their business arrangement or affiliation with an outside company seeking to have a business (advertising or marketing) relationship, most often only takes the form of signing a simple contract to display a banner advertisement or link, strategically displayed on the Web site establishment (such Web site establishments as those shown in Table-A) for a limited time period.

In effect an outside business customer seeking a business relationship contacts a Web site establishment (such as the Portals and Search Engines shown in Table-A), and comes to a contractual agreement to place a banner ad, or link on the Web site. The outside business customer honors the required compensation/payment, and in exchange the Web site establishment displays the banner ad or link at the agreed upon location, for a specified time period. Because the promotional or advertising options that are available to an outside customer is limited and standardized (with regard to how the banner ad or link can be displayed and how the Web site can be affected or altered), the pre-negotiation and actual contract signing can take only a matter of minutes.

Whenever two or more legal entities get together collaboratively for a common business purpose, the business relationships either takes the form as described above (where an outside business customer contracts, and conducts business with a Web site establishment), or they sometime form what are known as Joint Ventures (JV's). Such business arrangements require that each entity contribute either monetary funds, expertise, or some other tangible or intangible valued asset, in exchange for an agreed percentage of owner equity rights and privileges of the newly formed legal entity.

In effect, what distinguishes a Joint Venture is that the commodity being sold as part of this contractual arrangement is “equity” ownership of the operation. Owning equity in an Internet business operation, therefore seems to be the mandatory compensation requirement (depending upon the written JV agreements) an outside business customer has to receive, that grants permission to change the appearance and content of a Web site establishment (beyond what changes that are affected by a banner ad or link). Having the ability to affect the appearance and content of a Web site establishment (beyond what a banner ad or link can provide), transfers tremendous power to the recipient, since this provides potentially unlimited advertising and marketing control, and ability to communicate more effectively with your customer.

Unfortunately outside business customers are unwilling to engage in a Joint Venture agreement, for just the option/opportunity to communicate more effectively with its end-users/customers (beyond what a banner ad or link can provide), vis-á-vis a Web site establishment such as those shown in Table-A. As a result there is no in-between, the selection is either purchase banner ads or links on a Web site establishment, or purchase equity ownership through a JV agreement. The choice therefore is either limited input/control of the Web site establishment when you purchase banner ads or links, or at the other extreme (depending on the specific JV agreement), possibly complete control of how you can change the appearance and content of the Web site establishment through a JV agreement.

The establishment of a Joint Venture however (with it's large price tag, and legal issues), may be too drastic an action (or “overkill”) for what an outside business customer is willing to make. Consequently, a Joint Venture is not an option, and by default the outside business customer can only rely on the purchase of “space” on a Web site establishment, which comes in the form of banner ads and links.

At the same time, the Internet is more mature and developed than it was in the mid-'90's, and as a result requires greater effort, involvement, and interaction between an outside business customer and Web site establishment to achieve the desired results that both the customer and seller desire and need. Equally important and frustrating, is the realization that the outside business customer and Web site establishment should have the capability for a deeper relationship, much more so than other channels, where the limitations/structure of the medium actually restricts the interactions of the comparable affected parties.

One area of tremendous weakness that is in desperate need of reform is the capability of outside business customers to come together on a single Web site establishment, in a collaborative yet non-combative fashion. Also, another area in great need of change is the capability of an outside business customer to generate a robust interaction and connection with an end user (vis-á-vis an outside business customer who establishes a relationship with a Web site establishment, such as those in Table-A), representing a significant improvement versus what a banner ad or link can presently/only provide. Furthermore, what is needed is a Program Manager to bring everything together, to facilitate the ideas and directives of outside business customers in a collaborative multi-customer manner, as they collectively affect the Web site establishment in ways that develop a robust interaction and connection with the end user, and also serves as a unique marketing and advertising mechanism.

The mere placement of banner ads or hyperlinks provides minimal opportunity for an affiliate or business partner to engage the end-user. What is needed is a complete and radical change in the way the Web site establishment conducts business with outside business customers. As opposed to Web site establishments just selling space (either through banner ads or links) to outside business customers on a piece-meal/individual basis, the Web site establishment needs to work collaboratively with multiple outside business customers, effectively developing a Web site considered a central hub of multiple outside business customers. At the same time such Web site establishments would become a robust channel (previously unseen prior to the proposed invention) for outside business customers to interact with and reach their end-users.

As mentioned previously, from an outside business customer perspective, there is (unfortunately) no in-between. Outside business customers seeking a business relationship with a Web site establishment such as those shown in Table-A can at one extreme either purchase “space” (such as banner ads or links), or at the other extreme purchase “equity” (ownership) in a Web site establishment. There is no eCommerce business arrangement presently (other than a Joint Venture where equity is sold) where legal entities work in a collaborative yet non-combative fashion (all striving to achieve the same robust interaction and awareness between themselves and their end-users/customers), and have control over the appearance and content of the Web site establishment. Additionally, up till now these Web site establishments that sell “space” maintain their business relationships with outside customers at an arms length, with little opportunity for the outside business customer to be anything more than just an “outside business customer” relative to the Web site establishment. What is needed is a Web site establishment that by definition treats outside business customers not as “customers”, but as part of the organization. Such a relationship is non-existent unless you are part of a Joint Venture.

What is also needed is a Web establishment that forms a long-term business relationship with its outside business customers (also known as affiliates or business partners), where outside parties interact and make decisions together that affect the Web site in a “collaborative team” arrangement, within budgetary guidelines, representing an instrumental center of decision making on such Web site establishment. Instead of selling “space” for banner ads or links, or selling “equity” due to the formation of a Joint Venture, the Web site establishment sells a partnership or membership to the collaborative team arrangement, where the entire team is empowered, and has the equity ownership/control necessary to decide the best use of space, appearance, and content in a unique, novel, and previously unseen business manner on the Internet.

When the business relationship between an outside business customer and a Web site establishment has been little more than an agreement to place a banner ad or link, it is evident that it's merely a “passive” business affiliation. In contrast there is an ever-increasing demand and desire (with unfortunately up till now no apparent adequate method and apparatus) to work in an “active” manner with your affiliates. Moreover, to extend its capabilities to even greater levels, it would not be restricted in its dealings with outside business customers on an individual or independent basis, but instead establish a multi-business customer team approach in how it does business. In essence, the establishment of collaborative business teams. Clearly the methods and apparatus that are devised and utilized today are not working adequately to meet the desired results for either the outside business customer or the Web site establishment. Furthermore, click rates are down, banner advertising spending and revenue have hit rock bottom, and Internet Web site establishments are going bankrupt at unprecedented numbers. The use of an invention that puts into practice what is proposed, will result in a revenue stream for the Web site establishment that far exceeds what is possible with only banner ads and links, since most of their outside business customers will come from traditional “brick and mortar” establishments. This new/proposed method and apparatus will also result in an unparalleled advertising and marketing tool for the outside business customer, allowing them to connect with their customers in ways that have previously been unachievable.

### BRIEF SUMMARY OF THE INVENTION

The proposed invention involves a Web site establishment, which could be the type described as a Portal, Anchor, Regional Theme Site™, Search Engine, Infomediary, or a host of other names. Such Web site establishments (such as those shown, but not limited, in Table-A) under the proposed invention would offer a unique manner in which it does business with outside customers (with particular, but not mandatory, emphasis on “brick & mortar” outside business customers) who seek to establish an affiliate or business relationship. As contrasted to selling “space” to these outside business customers (such as a banner ad or link), what is sold is the membership, partnership, and acceptance into a collaborative Portal (or coPortal), but more specifically “equity” rights and privileges in a “coPortal Program Management Team” (or cPMT). The cPMT has the empowerment, control, and responsibility that affects changes to the appearance and content (within established budgetary guidelines) of the Web site establishment. Because of the revolutionary nature/class of such a Web site establishment, it is easily understood how this “next generation Web site” needs to be distinguished from the other Web site establishment categories shown in Table-A, hence the name “collaborative Portal” or “coportal” for short.

An outside business (corporate/enterprise) customer who participates in this initiative with a Web site establishment are known as a “coPortal Business Member” (or CBM), and they in-turn assign a specific company representative or “contact” to act in their behalf, which become known as the “coPortal Contact Member” (or CCM). Each CCM will interface and co-exist with other CCM's in a collaborative non-combative manner, under the guidance, direction, and control of a cPMT Program Manager (or just simply Program Manager).

The cPMT Program Manager is generally a professional employee of the coPortal, whose primary role and responsibility is to act as the person in charge of the cPMT. The Program Manager is also responsible for properly conveying the scope, influence, and limitations of the cPMT to its CCM's, as well as carrying out the membership's agreements and decisions as it affects the coPortal. Naturally this will require the Program Manager to work with the other activities and organizations of the coPortal to accomplish the actions and directives of the cPMT.

Each CBM enjoys certain rights and privileges. Such rights and privileges include (but is not limited) to strategically advertise/display their corporate logo on the coPortal, institute and utilize custom designed “Polls”, openly display current CBM stock valuations, openly display current CBM Press releases, posting of featured articles relative to the CBM, provide chat forum opportunities for the CCM to connect with Internet end users, and the opportunity for Web site end-users to receive email letters/bulletins directly from the CBM, represent only a partial list of how the CBM can utilize their membership rights and privileges to better advertise, market, and connect with their end-users/customers. Such examples in the real world will only be limited by the imagination of the cPMT, and their budget/authority allows. A distinguishing feature of the proposed method and apparatus, is that these privileges are part of the licensing arrangement that is custom designed and structured up-front when joining the cPMT, whereas on the present system that is utilized, all of these actions could possibly be available but only on a per-diem (or pay for what you get) basis to the outside business customer. Furthermore, under the prior system, contracts for banner ads or links are accomplished by purchasing either a set number of “impressions” (defined by the “CPM”, or “cost-per-thousand” impressions), or actual “click throughs” (defined by the “CPC”, or “cost-per-click”). Under the proposed method, the arrangement is based on the authority level (granted to the outside business customer, or CBM) and duration of the agreement (generally for a year or longer).

From a business arrangement standpoint, the CBM purchases “equity” into a specific cPMT. The cPMT Program Manager, as an example, could control a minimum 51% of the cPMT, and the CBM's collectively control the remaining “equity” of the cPMT. In-turn the cPMT, in the full embodiment of the apparatus, has control and responsibility for affecting the appearance and content of the coPortal, within certain guidelines and budgetary limitations that are established and defined upfront.

It is important to note that a coPortal is not prevented from utilizing some of the traditional Web site establishment methods that have been in use up till now (including the use of banner ads and links), to either run other areas of the Web site establishment, or to supplement the needs of enrolled CBM's as part of the up-front coPortal arrangement/agreement. Additionally, depending on the structure of the coPortal, it may be desirable to have several cPMT's, wherein each category or topic covered in the coPortal is assigned a cPMT, creating a tremendously powerful coPortal arrangement, heretofore unseen on the Internet.

In addition to all of the membership benefits that are made available to each CBM/CCM, there are also certain actions that the cPMT collectively is encouraged to exhibit. As an example, a coPortal devoted to the topic of automobiles, would not only utilize the web site and its cPMT membership to promote each of their present and future automotive products, but also (whenever possible) individually and collectively promote the automotive industry, as well as its history. Effectively each CBM/CCM is seen as playing a leadership position in this business arrangement, whose collective brand names, expertise in the field, reputation, and social responsibility, all contribute to creating a channel or medium considered to be the nucleus of communication, information, and education on a specific topic, that is previously unseen on the Internet.

The coPortal Program Management (cPM) process as described in this invention is heretofore unseen and unknown on the Internet. While prior art Web site establishments treat outside corporate/enterprise customers (who seek business affiliations and relationships) at an arms length, the present invention creates a reciprocating growth relationship between the coPortal and each CBM/CCM. Benefits to the coPortal, and each CBM are immense. From the coPortal perspective, the revenue provided from each CBM comes at a time when revenue is sorely needed and sought by every Web site establishment. From the CBM's perspective (especially “brick & mortar” corporations), an association with a coPortal provides an opportunity to establish a positive and unfiltered connection or pipeline to their consumers (on a mainstream Web site establishment) outside of the CBM's own corporate Web site.

As opposed to individual brick and mortar corporations launching their own separate “stand-alone” Web site establishment/entity for tens of million of dollars (such as PetsMart, Staples, BlueLight, etc. that were discussed previously), a coPortal CBM/CCM relationship could accomplish nearly similar results for these corporations (for advertising, marketing, attracting and connecting with their customers/end-users) at a very small fraction of the cost of what they would have to pay presently to achieve comparable results. What makes this possible under the described method and apparatus, is the “economy of scale” that's associated with the grouping of several CBM's (represented by their CCM's) in a cPMT.

Aside from the cost of membership to the cPMT, the CBM's only additional expense is the resources/efforts required of their CCM. From this standpoint the CCM's functional involvement with a cPMT can be easily accomplished on a part-time basis, since they need not maintain a physical presence at the coPortal home location, and their principal involvement will be communicating with the cPMT Program Manager, and other CCM's through online meetings, email, and periodic audio/video conferencing. On the other hand the cPMT Program Manager will have full responsibility for the coordination and control of the entire cPMT, working with all of the CCM's and the internal organizations of the coPortal, and hence requires a full-time dynamic individual who is (most likely) employed and reports to the coPortal.

### BRIEF DESCRIPTION OF THE DRAWINGS

The present invention is illustrated by way of example in the appending drawings. Understanding that these drawings depict only a typical embodiment of the invention and are not therefore to be considered limiting of its scope is essential. The invention and the presently understood best mode thereof will be described and explained with additional specificity and detail, through the use of the accompanying drawings in which:

FIG. 1 illustrates on a macro basis, the prior art dialogue and subsequent outcomes, between “outside business customers” seeking to conduct business with a “Web site establishment”.

FIG. 2 illustrates on a macro basis, under the proposed invention, the dialogue and subsequent outcomes of “outside business customers” seeking to conduct business with a “coPortal”.

FIG. 3 illustrates on a fully diagramed and detailed basis the preferred embodiment of the proposed invention, and the dialogue and subsequent outcomes of an “outside business customer” seeking to conduct business with a “coPortal”.

### GLOSSARY OF TERMS

cPM: coPortal Program Management; The dynamic communication, interaction, and decision making process between the coPortal Program Manager and the CCM's, to exercise and manage their coPortal authority and responsibilities.

cPMT: coPortal Program Management Team; A working group of business representatives, made up of a Program Manager and coPortal Contact Members (CCM's). In the preferred and complete embodiment, the cPMT has complete control/empowerment (within budgetary guidelines) for the layout, appearance, and content of a pre-determined portion of coPortal. The Program Manager (generally representing the coPortal), would maintain 51% control of the cPMT, while the CCM's, representing outside business customers (CBM's), collectively controls/owns the remaining “equity” of the cPMT.

CBM: coPortal Business Member; An outside business customer (generally a corporation or business enterprise) who desires to establish a business relationship with a coPortal, where they can conduct commerce, inform, promote, and/or advertise their business, goods, and/or services in a collaborative, cooperative, harmonious, and non-combative manner with other such outside business customers. These CBM commerce capabilities are made possible (within pre-defined rules and budgetary guidelines) through the “equity” ownership in the cPMT that has the authority to affect the appearance and content of the coPortal.

CCM: coPortal Contact Member; The representative, agent, or “contact” acting in behalf of a particular CBM, who participates in a collaborative, cooperative, harmonious, and non-combative manner in a cPMT with other CCM's.

coPortal: collaborative Portal; A Web site establishment, arranged and established for the benefit of outside business customers, whereby a number of CBM's (represented by CCM's), participate through a membership arrangement to conduct commerce in a unique, collaborative and non-combative manner. Principal among the CBM/CCM's sphere of authority, is their ability (within certain rules, authority, and budgetary guidelines) through the cPM process, to affect the appearance, and content of a pre-determined portion of the coPortal.

Outside Business Customer: Any business or legal entity who is desirous of establishing a business relationship (affiliation) with a Web site establishment (Portals, coPortals, Anchor sites, Search Engines, etc.).

Portal: A Web site establishment that represents a gateway, port, or opening to other Web sites. At the same time, a Portal may represent a self-contained and complete Web site establishment unto itself, where the end-user is fully satisfied and hence not interested in venturing onto other Web sites.

cPMT Program Manager: coPortal Program Manager or simply Program Manager, The Program Manager is generally a professional employee of the coPortal, whose primary role and responsibility is to act as the person in charge of the cPMT. The Program Manager is also responsible for properly conveying the scope, influence, and limitations of the cPMT to its CCM's, as well as carrying out the membership's agreements and decisions as it affects the coPortal.

Web Site Establishment: A Web site operation best described as a Portal, Anchor site, Search Engine, Infomediary, or Regional Theme Site. Examples of some current establishments are shown in Table-A.

### DETAILED DESCRIPTION OF THE INVENTION

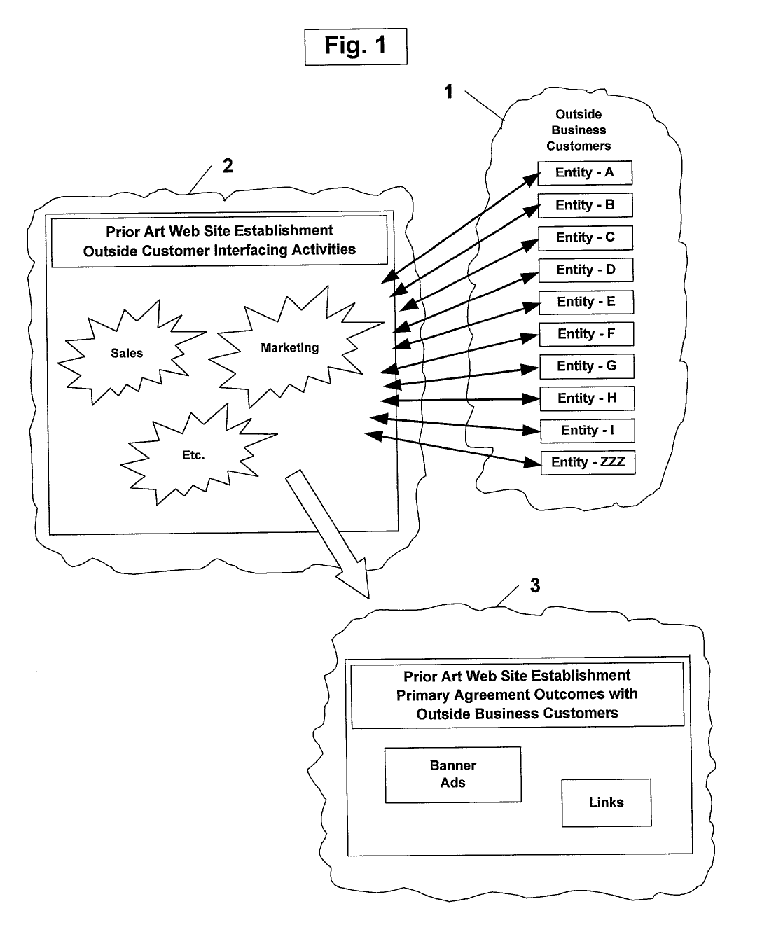

What is shown in FIG. 1 is a graphical illustration of the prior art on a macro basis, specifically the typical interaction between “outside business customers” seeking an affiliation with a Web site establishment (1), such as (but not limited to) those enterprise activities that would be considered among the Fortune 1000 or Global 1000 corporations, and the outside customer interfacing activities of a Web site establishment (2), such as (but not limited to) those that fit the definition and are mentioned in Table A. Generally speaking, outside customers (1) identified as Entity-A through Entity-ZZZ, make contact with one or more of the outside customer interfacing activities of a Web site establishment (2), asking questions, obtaining answers, and ultimately consummating a contract to do business.

The “need” to contact the Web site establishment (2) generally arises because of the “necessity” to conduct some sort of marketing or promotional campaign agreement for display on the Web site establishment, that most often wind up in an agreement to place a banner advertisement, banner announcement, or hyperlink (link for short) message (3). The outside customer (1) “needs” is generated from a multitude of business reasons. The back and forth dialogue that takes place between these two activities is an iterative process, a verbal and written exchange of information that for the skilled can take only a matter of a few minutes before it finally consummates in the signing of an agreement, and the reciprocal placement of the banner advertisement, link, or some other display on the Web site establishment (3).

Another distinguishing feature of the prior art is that the number of business transactions between outside customers (1), and a specific Web site establishment relative to its outside interfacing activities (2) and the display of banner ads and or links (3), is limitless. In this type of business model Entity-A can conduct business one time, or thousands of times with a specific Web site establishment. Furthermore, the number of business entities that conducts business with the Web site establishment is also limitless. We may find that several hundred or several thousand-business entities do repetitive business transactions with a specific Web site establishment. To accommodate this mass onslaught of buying patterns, each business sales transaction is designed to take the least amount of time and the least amount of effort for any/all outside customer interfacing activities of a Web site establishment (2).

In addition to verbal, written, or faxed agreements for banner ads, banner announcements, or links, the dialogue between an outside business customer (1) and a Web site establishment (2) can also take the form of a “web-based mechanized approach” of conducting business agreements. This web-based contract agreement is typical for Pay for Performance Search Engines (that are displayed in Table-A). Under this approach, there is very little if any human intervention in the agreement process. With this type of marketing effort there is no banner advertisement, but instead an agreement is made (electronically) to place a self described and written “link” on the Pay for Performance Web Site establishment, with agreements that the outside customer (1) will pay a pre-defined amount for every click that an Internet user clicks on such self described link (vis-á-vis the Pay for Performance Web site establishment).

The dialogue that does occur (either mechanical or human) between a specific outside business customer (1) and the outside customer interfacing activities of a specific Web site establishment (2), are invariably conducted independent of the discussions and dialogue of other outside business customers. This not only produces redundant work efforts (and hence additional expense) for the outside customer interfacing activities of the Web site establishment (2), but also produces results and agreements that the other outside customers (1) may oftentimes view as combative in nature to their previously run or forthcoming advertisement or promotional campaign.

In addition, the dialogue that occurs in the prior art between outside business customers (1) and the outside customer interfacing activities of a Web site establishment (2), rarely (if at all) extends beyond the organizational activity known as “Sales” within the Web site establishment. As a result, the mentality and true driving force for these Web site establishments, is to be able to show to management at the end of the day that an “advertising or promotional sales agreement” has been consummated with an outside business customer (1). In effect these “advertising and promotional sales agreements” (albeit in the form of banner ads, banner announcements, or links, or agreements to pay for each click on a site/record that's listed on a search engine, etc) is what generates revenue and keeps these Web site establishments operational. As an example, Yahoo! has been cited as using this type of advertising business model for as much as 90% of their revenue, with the remainder of their revenue coming from other sources. It is also worth noting that adoption of this prior art advertising business model (generated from sales for banner ad and links) is the primary cause of the collapse of the dozens upon dozens of Web site establishments.

Moreover, we also find that under this “sales” mentality of conducting business, the Web site establishment considers their obligations and requirements fulfilled once the advertising and promotional campaign has completed it's run on the Web site. Because of this pure “sales” approach for conducting business, there is no reason or rationale for the Web site establishment to get further involved, or follow-up with the outside business customers (1), since the Web site establishment (2) considers their mission completed, while the outside business customer (1) is left pondering (back in their own home office organizations) what is the next advertising or promotional campaign it needs to pursue.

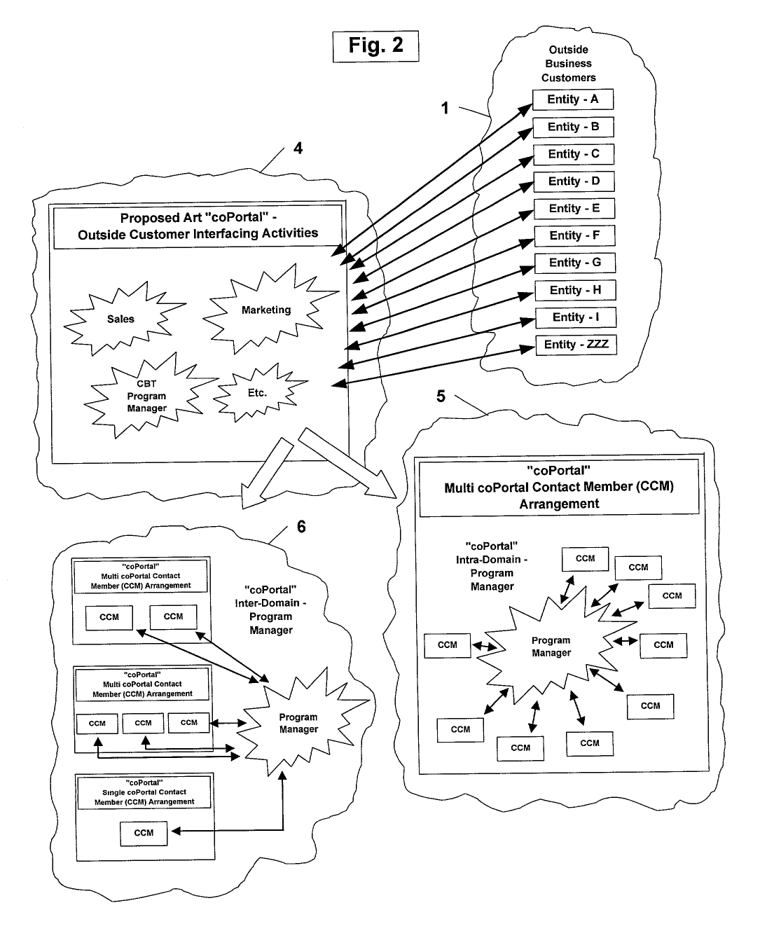

In contrast to FIG. 1 (representing the prior art), FIG. 2 on a macro level represents a suggested depiction and usage of the proposed novel invention that is hereto-fore unseen. What we find is that the same array of outside customers (1) exist, but they come in contact with a new type of Web Site establishment referred to as a “collaborative Portal” (or “coPortal” for short), and hence the outside business customer (1) establishes a dialogue with the coportal's outside customer interfacing activities (4).

Since a coPortal offers a different product or service than what is presently provided by a prior art Web site establishment (such as those prior art Web site establishments that are shown in Table-A), the outside business customer (1) has different reasons for wanting to engage in a coPortal relationship. Once the outside business customer (1) understands the coPortal product/service and is ready to establish a business association, it is during this early dialogue process that the outside business customer (1) and the coPortal's outside customer interfacing activities (4) determine if there is a good fit or match for the outside business customer (1) to participate in a “coPortal Program Management Team” (or cPMT for short). This also brings us to realize a distinguishing factor with the present invention, that the amount of business entities that does business with a coPortal is limited, as contrasted to a limitless number of business entities that can conduct business in the prior art.

The makeup of the outside customer interfacing activities of a coPortal (4) is also quite different than the outside customer interfacing activities of a prior art Web site establishment (2), the main difference being the inclusion of a cPMT Program Manager. The involvement of the cPMT Program Manager at this juncture is to ensure the best possible fit or selection of a particular business entity, among all of the outside business customers (1) applying for a coPortal membership, and against all of the other business entities that may have already signed up as an active participant of the cPMT. It is at this juncture that outside business customers (1) that are “signed-up” to join a coPortal's cPMT are defined as a “coPortal Business Member” (or CBM for short). Since the cPMT represents a dynamic work force machinery, the CBM must assign a “coPortal Contact Member” (or CCM for short) to act as its agent, working primarily with the cPMT Program Manager, but also with other CCM's.

One of the distinguishing features of a coPortal arrangement, versus traditional (prior-art) Web site establishments such as those shown in Table-A or discussed relative to FIG. 1, is the manner in which it receives its revenue or compensation from outside customers (1). In FIG. 1, revenue or compensation under the prior art inherently occurs as a “sales” agreement (which is more fully described above). In contrast, compensation for a coPortal, utilizing the coPortal Program Management (cPM) process, occurs upon signing a “membership” or “licensing” agreement with an outside business customer (1). It is through this arrangement that the outside customer (1) secures a long-term license agreement, and position in a cPMT.

Furthermore, because all cPMT members participate in this membership arrangement, the cPMT Program Manager (who becomes their primary interface) never becomes concerned about making a “sale”. The Program Manager is thus able to maintain his impartial focus in his dealings with any/all CBM's/CCM's. Additionally, the membership agreement that all of the CBM's must sign clearly states how each CBM and their designated CCM agree to a collaborative co-existence with the other CBM's/CCM's, where they must operate in a non-combative and unbiased relationship with their peers.

Since the cPMT Program Manager (who is responsible for supporting the CCM's on a regular basis) does not suffer from a “sales” based pricing mentality, the coPortal is not driven by “sales”, and hence all of the negative aspects surrounding the prior art revenue methodology no longer applies. As a result, the Program Manager and the coPortal it represents, is driven to accommodate the needs and requirements of its customers (the CBM and CCM), and in-turn the CBM and CCM are driven by their customers (the Internet end-users). Under the proposed art, we therefore find a significantly more desirable and appealing business arrangement, where everyone is customer (and not “sales”) focused and driven.

An additional distinguishing feature of the proposed invention, versus the prior art, comes only after understanding how the previous Web site establishments (some of which are identified in Table-A) provide advertising (such as banner ads or links), in a manner that basically connects the end-user to the corporate enterprise. In the prior art, the Web site establishment acts as an intermediary, whereas in the preferred embodiment of the proposed method and apparatus, the coPortal acts as the corporate enterprise (the “outside business customer”) itself, providing a “direct” (versus “indirect”) channel/connection to the end-user.

Upon the outside customer's (1) acceptance and inclusion as a CBM, a CCM could be assigned to a coPortal Intra-Domain-Multi coPortal Contact Member (CCM) arrangement (5). Under this configuration, the CCM would find themselves grouped with other CCM's, under a single Domain or Universal Resource Locator (URL) address. Because of the number of CCM's in the Intra-Domain-Multi coPortal Contact Member arrangement (5) scenario, there is a single coPortal Intra-Domain cPMT Program Manager assigned to facilitate the actions of the CCM's. Under this makeup, the interaction between the CCM's and the Program Manager is a dynamic communication and action process, where the Program Manager facilitates the needs and requirements of the CCM's within a singular URL Web site (“Intra-Domain”) arrangement.

In another embodiment, a coPortal Inter-Domain-cPMT Program Manager (6) may be a preferred arrangement. In this display a Program Manager is assigned to handle two or more Intra-Domain Web site arrangements, where we would find an Intra-Domain (or single Domain or URL) having a “Multi” or “Single” Contact Member (CCM). This particular layout is preferred when a Program Manager is not warranted for just one Intra-Domain arrangement, but only makes sense to have a Program Manager after grouping several Intra-Domain arrangements together.

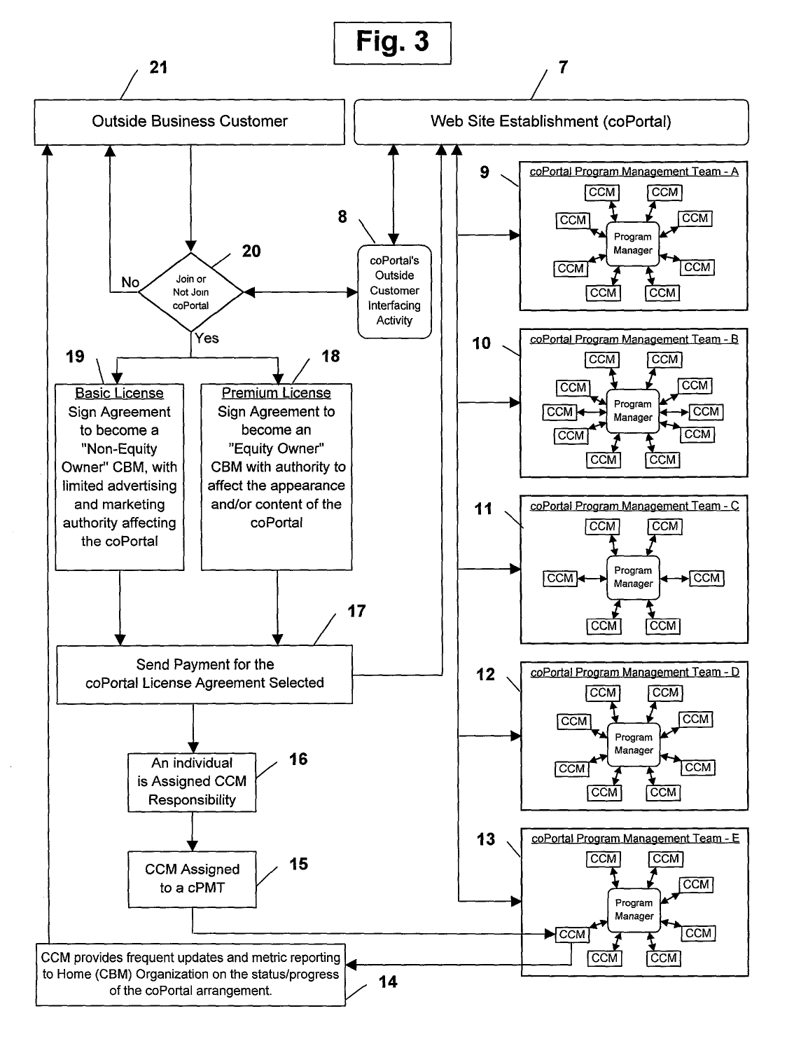

Shown in FIG. 3, is a detailed illustration of a coPortal arrangement. This illustration additionally shows the opportunity afforded to the outside business customer to obtain either a basic (19) or premium (18) licensing agreement with the coPortal. After the necessary signatures (18-19) and payments (17) are handled, the CBM (outside business customer) assigns a specific CCM to the project (16) who in-turn is assigned/introduced to the cPMT (15). In this preferred embodiment illustration, there are five Intra-Domain cPMT's (9-13), each or which are assigned a single Program Manager. Moreover, this illustrates an ideal arrangement where these five cPMT's are representative of five categorical (stand-alone) themed Web sites, and each cPMT is responsible for a different topic or themed Web site to regulate/control.

Whether configured with an “Intra-Domain” or “Inter-Domain” Program Manager, the proposed art method and apparatus can only function when the CBM, but more specifically the CCM, interacts in a collaborative, yet non-combative community of other CCM'S. Hence, the Business Team needs to interface with one another in a collaborative and non-combative fashion, to allow each CBM/CCM (on an individual and aggregate basis) create a greater and improved connection with their customers than what a prior art method and apparatus can provide.

It is important to note that the coPortal revenue pricing equation could be described as a “fee-based” or “licensing-based” model, which pays for membership in the cPMT. Since the CBM's would have to pay a larger monthly membership fee for a “premium license” coPortal arrangement, the monthly membership payment could be constructed to have a monthly payment that pays for everything except for items and features that utilize hyperlinks, which would then include an additional but modest “click-per-use” surcharge.

The steps outlined in the description of FIG. 3 are needed to achieve the full embodiment of the proposed invention. Also, it is important to point out that the present invention represents a significant advancement over the present system described as part of FIG. 1, which offers no Collaborative Portal (coPortal), coPortal Program Management Team (cPMT), coPortal Business Member (CBM), coPortal Contact Member (CCM), or a revenue equation that is membership/licensed based.

The opportunities and potential that is afforded an outside business customer, in terms of a relationship with a coPortal is immeasurable. As a result, affiliation in a coPortal/cPMT arrangement may eliminate the need for some brick and mortar corporations to develop more expensive Web establishment alternatives (including the formation of a “stand-alone legal entity” or a “Joint Venture”) for their business concerns. At a minimum, a coPortal/cPMT arrangement provides a clear and substantive alternative that is presently not available in the prior art schema.

One skilled in the art will understand that various modifications and alterations may be made in the preferred embodiment disclosed herein without departing from the scope or intent of the invention. Accordingly, because of the limitations of the verbal and written language, the embodiment of the invention should not be constrained to the particular wording or descriptive names (which could be easily replaced with other descriptive names) discussed above. It is the spirit of the invention that needs to be protected and patented, where it can only be shaped, and defined by the claims set forth below and equivalents thereof. Furthermore, because modifications and changes will be made to these embodiments without departing from the broader spirit and scope of the invention as set forth in the claims, the drawings and specifications should be regarded as illustrative rather than restrictive.

What we claim as the invention is:

1) A method for establishing a collaborative program management concept to conduct business within a Web site establishment, in conjunction with outside business customers wishing to form a business affiliation, through the:
a) Creation of a program management team(s), administered by a Program Management process, to recommend actions that affect the Web site establishment and also its team members.
b) Admission of a Program Manager(s), and outside business customers who may be represented by an agent or company contact, as members in the program management team(s).
c) Interaction of the program management team members in a collaborative working member setting and arrangement.
d) Appointment of the Program Manager(s), who may or may-not be an employee(s) or agent(s) of the Web site establishment, to operate and manage the program management team.

2) The method of claim 1, wherein said Web site establishment is a Portal Web site.

3) The method of claim 1, wherein said Web site establishment is an Anchor Web site.

4) The method of claim 1, wherein said Web site establishment is a Search Engine Web site.

5) The method of claim 1, wherein said Web site establishment is an Infomediary Web site.

6) The method of claim 1, wherein said Web site establishment is a Regional Theme Site.

7) The method of claim 1, wherein said Web site establishment are all those remaining Web sites not mentioned in claims 2-6.

8) The method of claim 1, wherein step (a) program management team is contractually authorized to affect the appearance and/or content of the Web site establishment.

9) The method of claim 8, wherein said Web site establishment is a Portal Web site.

10) The method of claim 8, wherein said Web site establishment is an Anchor Web site.

11) The method of claim 8, wherein said Web site establishment is a Search Engine Web site.

12) The method of claim 8, wherein said Web site establishment is an Infomediary Web site.

13) The method of claim 8, wherein said Web site establishment is a Regional Theme Site.

14) The method of claim 8, wherein said Web site establishment are all those remaining Web sites not mentioned in claims 9-13.
